(19) United States
(12) Patent Application Publication
(10) Pub. No.: US 2011/0154415 A1
(43) Pub. Date: Jun. 23, 2011

(54) MULTICASTING VIDEO ON DEMAND (VOD) SERVICE SYSTEM AND METHOD USING CHANNEL MERGING

(75) Inventor: Jeong Yun KIM, Daejeon (KR)

(73) Assignee: Electronics and Telecommunication Research Institute, Daejeon (KR)

(21) Appl. No.: 12/975,140

(22) Filed: Dec. 21, 2010

(30) Foreign Application Priority Data
Dec. 21, 2009 (KR) 10-2009-0128051

(51) Int. Cl. H04N 7/173

(52) U.S. Cl. 725/95

(57) ABSTRACT

Provided is a multicasting Video on Demand (VOD) service system and method using channel merging. The multicasting VOD service system using channel merging may include: a video server to transmit a stream at a speed higher than a playback rate, and to merge at least two input/output (I/O) stream channels when the at least two I/O stream channel transmit the same content; a channel processor to calculate a high transmission speed for combining two channels having different playback points in times, and to request the video server for a high speed transmission including the calculated high transmission rate; and a terminal equipment to store a stream content received at the speed higher than the playback rate, and to play the stored stream content.

### CROSS-REFERENCE TO RELATED APPLICATION

This application claims the benefit of Korean Patent Application No. 10-2009-0128051, filed on Dec. 21, 2009, in the Korean Intellectual Property Office, the disclosure of which is incorporated herein by reference.

### BACKGROUND

1. Field of the Invention

Embodiments of the present invention relate to a multicasting Video on Demand (VOD) service system and method using channel merging, and more particularly, to a multicasting VOD service system and method using channel merging in which a video server transmitting streams having different transmission points in times with respect to the same content may transmit a stream having a late transmission point in time at a high rate, i.e., adjust a stream transmission speed, i.e., a stream transmission rate of a channel until all the stream channels have the same transmission point in time in order to equalize the transmission point in time, and may remove a corresponding channel ever time the corresponding stream channel has the same transmission point in time and thereby may remove remaining channels excluding only a final single channel.

2. Description of the Related Art

Generally, a Video on Demand (VOD) service denotes a tailored image information service that may provide an image requested by a user at a desired point in time, over a communication network connection. Conventional VOD services may use a streaming scheme that enables a VOD server to transfer a video in real time at a playback speed of a terminal equipment replaying the video.

A Download and Play (DNP) scheme denotes a service scheme that enables the terminal equipment to first download all video contents and then start playing the downloaded video contents.

A Progressive Download (PDL) scheme or a Hypertext Transfer Protocol (HTTP) streaming scheme being currently used may have advantages of a real-time characteristic of the streaming scheme and a high quality play of the DNP scheme. Specifically, the PDL scheme may simultaneously download and play a video using video meta information. Also, the PDL scheme may quickly transfer a high quality of video suitable for a network environment using a Transmission Control Protocol (TCP).

In a VOD transmission, an input/output (I/O) band of a video storage server may correspond to an important throughput of a VOD system determining a number of simultaneously available service channels. Accordingly, research on a scheme of effectively using the I/O band is actively conducted.

In this research, so as to reduce a usage rate of the I/O band, a piggybacking scheme may employ the following scheme with respect to channels requesting the same video: When “1” I/O band is used to transmit the video to a first channel, “1” additional I/O band may be used for a second channel requesting the service. To reduce a usage rate of the I/O band, that is, to reduce the I/O band used for two channels to the I/O band used for a single channel, it is possible to increase a video transmission speed of the second channel compared to a play time of a terminal equipment, and to decrease a video transmission speed of the first channel. Once two channels transmit the same information of a video stream (also referred to as a time zone) after an amount of time (M) is elapsed, there is no need to maintain the I/O band assigned to each channel. Accordingly, only the I/O band corresponding to a single channel may be used for two channels. When a plurality of channels transmit the same information of a video stream, only the I/O band assigned to a single channel may be maintained and I/O bands assigned to remaining channels may enter an idle state. Thus, it is possible to save the I/O bands of the remaining channels.

Since a human being does not recognize any changes in a video playback speed within the range of about 5%, the piggybacking scheme may adjust a video transmission speed to be within the range of −5% to +5% compared to a normal playback rate. Accordingly, to decrease a usage rate of the I/O band under the condition that the video transmission speed is to be adjusted within a narrow range, a service start time difference between channels connected to the video storage server needs to be small. For example, when a video play time is 60 minutes, and a service start time difference between two channels to play a corresponding video is about 30 minutes, the same information may not be streamed during the video play time and thus the piggybacking scheme may be inapplicable.

### SUMMARY

An aspect of the present invention provides a multicasting Video on Demand (VOD) service system and method using channel merging that may enhance a usage efficiency of an input/output (I/O) channel of a video server by merging stream channels transmitting the same content.

According to an aspect of the present invention, there is provided a multicasting Video on Demand (VOD) service system using channel merging, the system including: a video server to transmit a stream at a speed higher than a playback rate, and to merge at least two stream channels when the at least two stream channel transmit the same content; a channel processor to calculate a high transmission speed for combining two channels having different playback points in times, and to request the video server for a high speed transmission including the calculated high transmission rate; and a terminal equipment to store a stream content received at the speed higher than the playback rate, and to play the stored stream content.

The video server may transmit the stream to the terminal equipment at the speed higher than the playback speed of the terminal equipment according to a VOD service transfer scheme.

The video server may inform the channel processor about a difference between transmission points in times of stream channels transmitting the same content.

The video server may transmit a corresponding content at a transmission speed requested by the channel processor.

When the transmission points in times of stream channels transmitting the same content become to be the same, the video server may remove remaining channels excluding only a single stream channel.

The channel processor may determine a transmission speed required to remove the difference between transmission points in times, based on available resource information of a network, the terminal equipment, and the video server, and may request the video server to transmit the stream at the determined transmission rate.

When a stream transmitted at a speed higher than a normal playback speed is received, the terminal equipment may store the stream.

According to another aspect of the present invention, there is provided a multicasting VOD service method using channel merging, the method including: retrieving, by a video server, stream channels transmitting the same content; calculating, by the video server, a difference between transmission points in times of the stream channels transmitting the same content to inform a channel processor about the calculated difference; calculating, by the channel processor, a high transmission speed of the video server using available I/O stream channels of the video server, and available resources such as a stream storage device of the terminal equipment and the like; transmitting, by the video server, the stream at the same high speed as received transmission speed information; and removing remaining channels excluding only a single channel when transmission points in times of stream channels become same with respect to the same content.

### EFFECT

According to embodiments of the present invention, a multicasting Video on Demand (VOD) service system using channel merging that may enhance a usage efficiency of input/output (I/O) stream channels of a video server by merging I/O streams assigned to transmit the same content, and may also increase a number of contents that may be simultaneously serviced by the video server without increasing a capacity of the video server.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a multicasting Video on Demand (VOD) service system using channel merging according to an embodiment of the present invention;

FIG. 2 is a diagram illustrating an example of merging and transmitting stream channels using channel merging according to an embodiment of the present invention; and

FIG. 3 is a flowchart illustrating a multicasting VOD service method using channel merging according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

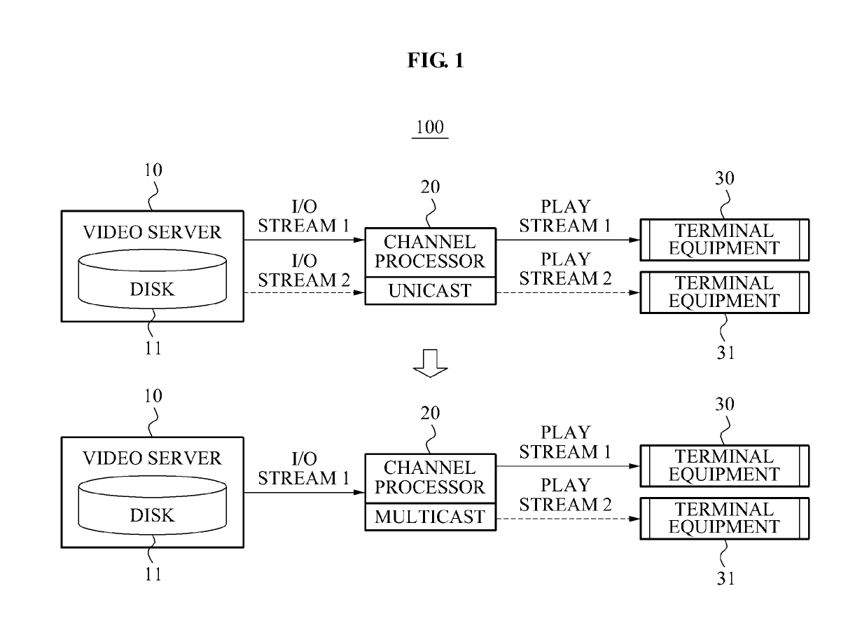

FIG. 1 is a diagram illustrating a configuration of multicasting a Video on Demand (VOD) service system 100 using channel merging according to an embodiment of the present invention.

Referring to FIG. 1, the VOD service system 100 may include a video server 10, a channel processor 20, and terminal equipments 30 and 31.

The video server 10 may transfer, to the terminal equipments 30 and 31, a video stream stored on a disk 11. Specifically, the video server 10 may transfer the video stream immediately after the terminal equipments 30 and 31 request a streaming service. Accordingly, it is possible to decrease a delay time.

The video server 10 may transmit streams to the terminal equipments 30 and 31 in response to a request order of each of the terminal equipments 30 and 31. Even though the video server 10 transfers the same video content, the video server 10 may transmit two stream channels to the terminal equipments 30 and 31.

When the video server 10 senses that at least one stream channel transmits the same content, the video server 10 may inform the channel processor 20 about the above event and a difference between transmission points in times of stream channels.

The channel processor 20 may determine a transmission speed, i.e., a transmission rate required to remove the difference between the transmission points in times of the stream channels, based on available resource information of a network, a terminal, and the video server 10, and may request the video server 10 to transmit a stream at the determined transmission rate. The channel processor 20 may be configured as an independent system such as a single proxy or a functionality belonging to the video server 10.

The video server 10 may start transmitting the stream at the transmission speed requested by the channel processor 20, and may merge channels every time transmission points in times of stream channels become equal. The above procedure may be continued until a number of stream channels transmitting the same content is one. A resource assigned to a channel that is merged and thereby deleted may be released.

In the terminal equipment 30 receiving the video stream at a normal rate, a received speed of the video stream is the same as a playback speed of the video stream.

The terminal equipment 31 receiving the video stream transmitted at a speed higher than the terminal equipment 30 may store, in a disk, the video stream received at the speed higher than the playback rate, and may read and play the disk. In this instance, the terminal equipment 31 may need a disk space capable of storing the video stream corresponding to an allowed difference between transmission points in times of channels, generally, an amount of ½ time of content playback time.

As described above, the VOD service system 100 may enhance a usage efficiency of stream channels of the video server 10 by merging stream channels assigned to transmit the same video content.

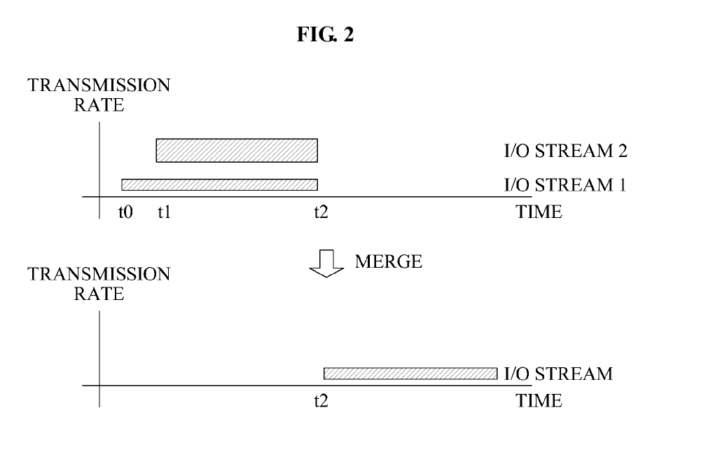

FIG. 2 is a diagram illustrating an example of merging and transmitting stream channels using high speed transmission according to an embodiment of the present invention.

Referring to FIG. 2, due to a service request time difference, a time delay corresponding to t1−t0 may occur in stream channel 2 compared to stream channel 1. To merge the stream channels 1 and 2, the video server 10 may transmit the stream channel 2 to the channel processor 20 at a transmission speed of N times a transmission speed of the stream channel 1. When the stream channels 1 and 2 transmit the same part of a content at a time t2, the video server 10 may stop the stream channel 2 and continuously maintain only the stream channel 1, i.e., may merge the two channels.

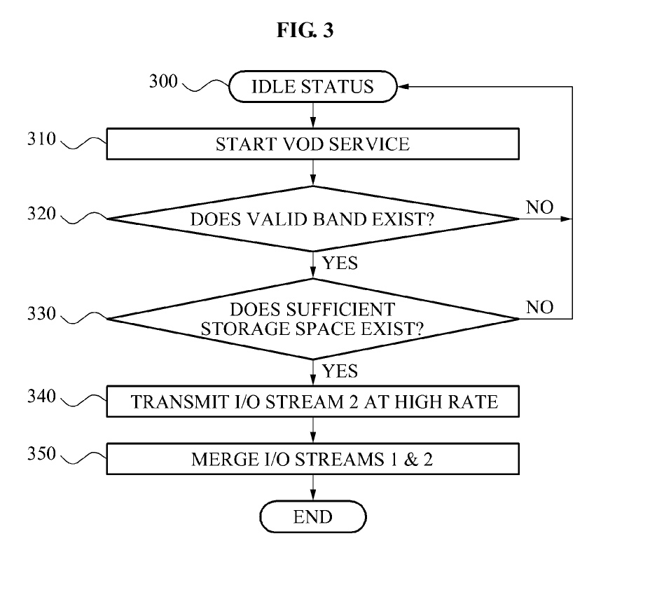

FIG. 3 is a flowchart illustrating a multicasting VOD service method using channel merging according to an embodiment of the present invention.

Referring to FIG. 1 and FIG. 3, the video server 10 may be in an idle state before receiving a video transmission request in operation 300. Specifically, in the idle state, the video server 10 may monitor whether the video transmission request is received from each of the terminal equipments 30 and 31.

When a message requesting a transmission of the same video content is received from each of the terminal equipments 30 and 31, and the like, at a predetermined point in time, the video server 10 may generate stream channels corresponding to the received request message and transmit the video content in operation 310. Specifically, when messages requesting the same video content are received from the terminal equipments 30 and 31, the video server 10 may start the multicasting VOD service using channel merging by informing the channel processor 20 about a difference between transmission points in times of stream channels transmitting the same content.

In operation 320, the channel processor 20 may verify whether a network band and an available resource of the video server 10 to be used for high speed transmission exist. When the available resource does not exist, the video server 10 may cancel the multicasting VOD service using channel merging and start a general unicast VOD video service.

Conversely, when the available resource exists, the channel processor 20 may verify whether a sufficient storage space to store a stream to be transmitted at a high speed exists in the terminal equipments 30 and 31.

In operation 340, when the sufficient storage space exists in the terminal equipments 30 and 31, the video server 10 may transmit the content at a speed of N times a speed of the stream channel 1. The content transmitted in advance at the high speed may be stored in the corresponding terminal equipments 30 and 31.

In operation 350, when the transmission points of the channels become equal, the video server 10 may stop the stream channel 2 and maintain only the stream channel 1 in order to merge the stream channels 1 and 2.

As described above, a multicasting VOD service method using channel merging according to an embodiment of the present invention may enhance a usage efficiency of stream channels of a video server by merging stream channels assigned to transmit the same video content.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multicasting Video on Demand (VOD) service system using channel merging, the system comprising:
a video server to transmit a stream at a speed higher than a playback rate, and to merge at least two stream channels when the at least two stream channel transmit the same content;
a channel processor to calculate a high transmission speed for combining two channels having different playback points in times, and to request the video server for a high speed transmission including the calculated high transmission rate; and
a terminal equipment to store a stream content received at the speed higher than the playback rate, and to play the stored stream content.

2. The system of claim 1, wherein the video server transmits the stream to the terminal equipment at the speed higher than the playback speed of the terminal equipment according to a VOD service transfer scheme.

3. The system of claim 1, wherein the channel processor verifies whether a network band and an available resource to be used by the at least two streams exists.

4. The system of claim 3, wherein when the available resource exists, the channel processor verifies whether a sufficient storage space to store the stream content to be transmitted at a high speed exists in the terminal equipment.

5. The system of claim 1, wherein when a transmission point in time of a normal speed stream channel becomes to be the same as a transmission point in time of a high speed stream channel, the video server releases the high speed stream channel and maintains the normal speed stream channel.

6. The system of claim 1, wherein when an available resourced does not exist, when an available network band does not exist, or when a storage space to store a stream content to be transmitted to the terminal equipment at a high speed does not exist, the video server stops the multicasting VOD service using channel merging, and starts a general VOD service providing procedure.
